(19) United States
(12) Patent Application Publication
(10) Pub. No.: US 2014/0002441 A1
(43) Pub. Date: Jan. 2, 2014

(54) TEMPORALLY CONSISTENT DEPTH ESTIMATION FROM BINOCULAR VIDEOS

(71) Applicants: Chun Ho Hung, Hong Kong (HK); Li Xu, Hong Kong (HK); Jiaya Jia, Hong Kong (HK); Lu Wang, Shenzhen (CN)

(72) Inventors: Chun Ho Hung, Hong Kong (HK); Li Xu, Hong Kong (HK); Jiaya Jia, Hong Kong (HK); Lu Wang, Shenzhen (CN)

(73) Assignee: Hong Kong Applied Science and Technology Research Institute Company Limited, Hong Kong (HK)

(21) Appl. No.: 13/537,087

(22) Filed: Jun. 29, 2012

(51) Int. Cl. G06T 15/00

(52) U.S. Cl. 345/419

(57) ABSTRACT

The present invention relates to method and apparatus for temporally-consistent depth estimation. Such a depth estimation preserve both object boundary as well as temporal consistency using techniques of segmentation and pixel trajectory.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to digital video processing and computer vision. In particular, the present invention relates to depth estimation.

### BACKGROUND

Human vision is capable of generating a perception of distance so that we can have a sense of how far an object is. The term “distance” is also known as “depth” whereas these two terms will be used interchangeably hereinafter.

The capability of human vision in measuring depth is based on stereo images—the left view and the right view. Therefore, a field of computer study has been developed to mimic human vision so as to obtain depth information or build a 3D model of the physical world from stereo images. Such a field of computer study is known as computer vision.

Many computer vision tasks require reliable depth estimation as well as motion estimation in order to ensure the production of results with high quality, for example, with higher accuracy. Therefore, there has been a keen pursuit of improving the reliability in depth estimation in this field of applications.

Usually, the depth information for each pixel of an image is presented in form of a matrix such as

$$[ \begin{matrix}{d}_{1} & {d}_{2} \\ {d}_{3} & {d}_{4}\end{matrix} ]$$

for a 2×2 image. Such a matrix is also commonly known as depth map. In general, a map is the presentation of results from processing an image in a form of matrix, for example, depth map for depth estimation results, edge map for edge detection results, etc.

Since a sequence of images, be them stereo images or not, are known as a video and one particular image at a particular time instance in a video is denoted as a frame, the terms “image” and “frame” are used interchangeably hereinafter.

### SUMMARY OF THE INVENTION

The present invention provides a temporally-consistent depth estimation by solving a number of problems including:

(1) Long-range pixel trajectory

(2) Object boundary preservation of recovered depth sequence

(3) Temporal consistency of recovered depth sequence

One example for possible application of the present invention is related to 3D video editing which becomes increasingly important as 3D movies or any 3D multimedia or entertainments have become more and more popular these days. If it is possible to recognize depth accurately in a 3D video, which is in essence a sequence of stereo images, a number of 3D video editing tasks which are traditionally challenging can be accomplished much more easily, for example, altering color, altering structure, altering geometry, recognizing a high-level scene or understanding a high-level scene.

Another example for possible applications of the present invention is to generate new views for 3DTV and it is particularly important in the light of the prevailing trend of use of 3D displays as well as 3D capturing devices in which the “2D-plus-depth” format is adopted as signal input or output and the present invention can advantageously provide better results for depth estimation.

One aspect of the present invention is to first compute image segmentation per frame and then use the resulting segmented frames together with long-range pixel trajectory to identify salient object boundary and obtain consistent edge maps. In other words, employing long-range pixel trajectory on per-frame image segmentation aids the depth estimation process without the need of segmenting each image column to each segment nor the need of computing foreground/background segmentation based on the computed stereo matching.

One aspect of the present invention is related to the input requirements. In one preferred embodiment, only a sequence of stereo images is used as inputs. Therefore, it is unnecessary for the present invention to utilize any special device or prior processing to enhance the image signal before performing motion or depth estimation. The sequence of stereo images may be obtained from, for example, a binocular camera or a pair of cameras capturing the same scene at different viewpoints which are commonly and commercially available in the market. This advantageously gives the present invention a higher applicability and flexibility when it comes to implementation. Nevertheless, it is also possible to adopt various techniques to enhance the input images in other embodiments of the present invention.

One aspect of the present invention is to increase the computational efficiency. For example, instead of using multi-view images for depth estimation which theoretically attains higher accuracy, the present invention can ensure at least the same level of accuracy or more by computing the correspondences from the left frame and the right frame of a set of stereo images. Nevertheless, multi-view images may also be used as one of the embodiments.

The present invention further offers a number of advantages, for example:

One advantage of the present invention is to provide temporal consistency and boundary preservation for depth estimation apparatus and method.

Another advantage of the present invention is to solve the occlusion problem and perform consistent depth refinement by computing long-range trajectory.

Another advantage of the present invention is that no additional devices or inputs are required apart from a sequence of binocular images.

The present invention is applicable to dynamic binocular videos and is capable of suppressing random foreground fattening artifacts to a large extent by using temporally consistent edge maps to guide the depth estimation process. Using temporal refinement, the present invention greatly suppresses the flickering artifacts and improves temporal consistency of depth maps.

Other aspects of the present invention are also disclosed as illustrated by the following embodiments.

### BRIEF DESCRIPTION OF THE DRAWINGS

These and other objects, aspects and embodiments of this claimed invention will be described hereinafter in more details with reference to the following drawings, in which:

FIG. 1 shows a flowchart of an exemplary embodiment of generation of a temporally-consistent depth map from binocular sequence.

FIG. 2 shows a flowchart of an exemplary embodiment of generation of an edge map provided by the present invention.

FIG. 3 shows an illustration of how to obtain long-range pixel trajectory in one exemplary embodiment.

FIG. 4 shows a flowchart of an exemplary embodiment of generation of a depth map provided by the present invention.

### DETAILED DESCRIPTION OF THE INVENTION

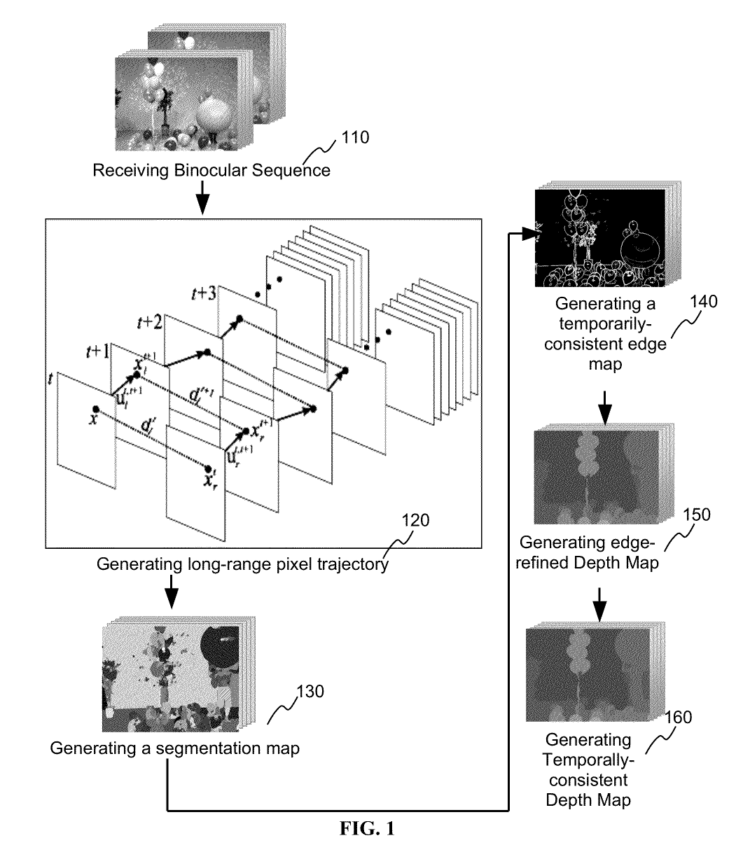

FIG. 1 shows a flowchart of an exemplary embodiment of generation of temporally-consistent depth maps from binocular sequence. Using a sequence of binocular images, i.e. binocular sequence 110, or also known as binocular video or stereo images or stereo video as an input, the present invention involves generation of long-range pixel trajectory 120. Each pair of binocular images 110 are different views of the same scene taken at a time instance t. For other binocular images 110 in a binocular video or sequence, they are pairs of images taken at different time instances, for example, t+i. A device or an apparatus or a system will receive this binocular sequence 110 and process the same using one or more processors. Such input or output or any intermediate product will be stored in computer-readable storage devices for further processing.

Long-range pixel trajectory 120 of an image is generated by identifying a correspondence of each pixel in an image at time instance t in other images at other time instances t+i in the binocular sequence 110. For example, a pixel in the left view of the binocular image pair, its optical flow is determined by its correspondence in the left view of the binocular image at next time instance which can be represented by a motion vector between the pixel itself and its correspondence. The long-range pixel trajectory 120 is the optical flow of a pixel through a number of images at different time instances. A discussion on optical flow estimation is available in SUN, Deqing, et al., “Secrets of optical flow estimation and their principles”, 2010 IEEE Conference on Computer Vision and Pattern Recognition (CVPR), pp. 2432-2439 and the same is incorporated herein by reference. And a discussion of trajectory estimation is available in Liu, Shuo, “Object Trajectory Estimation Using Optical Flow” (2009). All Graduate Theses and Dissertations. Paper 462. http://digitalcommons.usu.edu/etd/462.

For optical flow maps across longer temporal distance, a number of short range optical flow maps will be generated first so that the short-range optical flow maps can be concatenated together to form a long-range optical flow map, i.e. the long-range pixel trajectory 120. Alternatively, the short-range optical flow maps are processed using bilateral interpolation to obtain a number of interpolated optical flow maps, and these interpolated optical flow maps are concatenated together to form an initial long-range optical flow map. Each initial long-range optical flow map will be processed by linearization technique to achieve higher accuracy.

The occlusion status of a pixel represents whether there is an occlusion occurs to that pixel in other time instances. The trajectory of a pixel is broken once it is determined that there is an occlusion for the pixel in an image at that particular time instance.

Since the trajectory of a pixel is defined by its optical flow correspondences in neighboring frames, if more than one pixels in an image at time instance t have the same correspondence in an image at time instance t+i, then all such pixels will be marked as occluded.

The images from the binocular sequence 110 will also be segmented into different image regions by clustering the pixels in each image and the segmentation results are represented in a segmentation map 130 for each image so that pixels from the same cluster will be assigned with the same value in the segmentation map 130. For example, a segmentation map 130 is generated by mean-shift segmentation. Other segmentation methods may also be used in other embodiments, for example, similarity graph based methods, local variation method, source-sink minimum cut method, normalized cut method, etc.

Suppose a pixel has a correspondence in an image at time instance t+i, if such correspondence belongs to the different segments when compared with the correspondence of a neighboring pixel, the probability of such a pixel being on an object boundary is increased. One representation of such an increase in probability for a pixel being an object boundary is to determine the probability by counting how many neighboring pixels to such a pixel have correspondences in different segment and then dividing the total counts by the total number of the neighboring pixels. The correspondence in the image at time instance t+i of a pixel is determined by an optical flow of the pixel.

A temporally-consistent edge map 140 of an image from the binocular sequence 110 is generated by determining the probability of a pixel in an image being an object boundary using the segmentation map 130 and the long-range pixel trajectory 120 so that the edges in an image are identified and depth boundary can be preserved when generating a depth map using such a temporally-consistent edge map 140.

An edge-refined depth map 150 is generated for the binocular image pair using the temporally-consistent edge map 140 such that the probability of a pixel being a depth discontinuity is determined based on the probability of such a pixel being on an object boundary. The higher the probability a pixel being an edge is, the higher the probability a depth discontinuity will occur to that pixel. The probability of a pixel being an edge is used to control the smoothness in the estimation process so that smaller depth smoothness is applied if it is more likely that the pixel is an edge in an image. The computed edge-refined depth map 150 can preserve salient object boundary.

A temporally-consistent depth map 160 is generated for the binocular image pair from the edge-refined depth map 150 using the long-range pixel trajectory 120 to adjust the depth of a pixel according to the optical flow of such a pixel in at least one image at other time instances.

To avoid random foreground fattening artifacts, an averaging step is applied to the edge-refined depth maps of images at different time instances t+i using the pixel trajectory, for example, by applying Gaussian-weights to the depth values in the edge-refined depth maps. Such an averaging step is to make the difference among various depth values of the pixel and of its neighboring pixels to become smaller to eliminate the fattening artifacts.

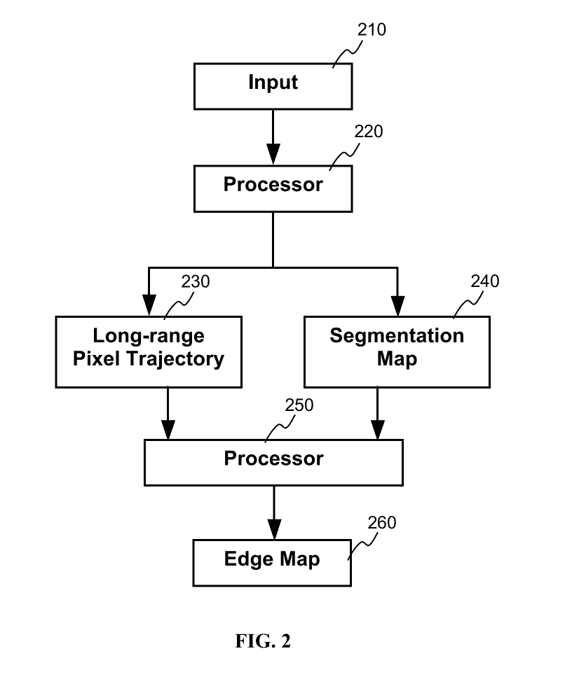

FIG. 2 shows a flowchart of an exemplary embodiment of generation of edge map provided by the present invention. The present invention takes a sequence of binocular images as an input 210. After processing the input 210 by one or more processors, the present invention will generate an edge map 260 for each frame of the binocular sequence and the edge maps 260 are used to guide the depth estimation.

The processing of every frame in the input 210 generates a set of edge maps 260, more particularly a set of consistent edge maps so that depth boundary can be preserved. To ensure the consistency of edge maps 260, long-range pixel trajectory 230 and single-frame segmentation maps 240 are used. The processor 220 is used to generate the long-range pixel trajectories 230 and single-frame segmentation maps 240.

Long-range pixel trajectories 230 are obtained by concatenating short-range optical flow maps with the consideration of occlusion and an embodiment for the production of long-range pixel trajectories 230 will be further discussed in details below. The segmentation map 240 for each frame is generated using the mean-shift segmentation. In general, mean-shift segmentation is to consider the following kernel-density estimate to obtain the probability of feature vectors \vec{F}(\vec{x}) from a given image.

$${p}_{K} ( \vec{F} ) = \frac{I}{\vert X \vert} {\sum }_{x ∈ X}^{ } K ( \vec{F} - \vec{F} ( \vec{x} ) ) , with \vec{F} ∈ {R}^{D} \qquad ( 1 )$$

where X is the set of all pixels in the image, |X| is the number of pixels, and K(\vec{e}) is a kernel. In one embodiment, K(\vec{e}) takes the following form:

K(\vec{e})=k(\vec{e}^{T}Σ⁻¹\vec{e}, (2)

Given s=\vec{e}^{-T}Σ⁻¹\vec{e}, then the examples for kernel K(\vec{e}) include the following:

k(s)=ce^{-s/2} for a Gaussian kernel (3)

k(s)=└1−s┘₊, for an Epanechnikov kernel (4)

where c=c(Σ) is a normalizing constant to ensure K(\vec{e}) integrates to one, and └z┘₊ is positive rectification, i.e. └z┘₊=max(z,0).

The segmentation map 240 per frame is a matrix of segmentation labels which are the results from finding the modes, i.e. peaks, of the equation (1), as shown in the following equation:

$${\vec{F}}_{*} = arg {max}_{{F}^{}} {p}_{K} ( \vec{F} ) \qquad ( 5 )$$

By iterating the following mean-shift equation:

$${\vec{F}}_{*} = [ {\sum }_{x ∈ X}^{ } w ( \vec{F} ( \vec{x} ) - {\vec{F}}_{*} ) \vec{F} ( \vec{x} ) ] / [ {\sum }_{x ∈ X}^{ } w ( \vec{F} ( \vec{x} ) - {\vec{F}}_{*} ) ] \\ where w ( \vec{e} ) = - {k}^{′} ( {\vec{e}}^{T} {\sum }_{ }^{- 1} \vec{e} ) and {k}^{′} ( s ) = \frac{d k}{d s} ( s ) \qquad ( 6 )$$

The segments produced by mean-shift segmentation are defined to be the domains of convergence of the above mean-shift iterations as denoted by equation (6).

The edge map 260 for each frame is generated by a processor 250 using long-range pixel trajectories 230 and segmentation maps 240. A voting-like scheme is employed with the use of long-range pixel trajectories 230 and these segmentation maps 240, to identify the probability of each pixel being on an object boundary.

Regarding the voting-like scheme, given each pixel x in frame p at time instance t, its correspondence x′ in frame q at time instance t′ is located by optical flow maps.

Given a neighboring pixel of x is denoted by y and the correspondence of y in frame q is denoted by y′, if x′ and y′ belong to different segments in the segmentation map 240, the pixel x will receive a “vote” confirming that it is on object boundary. Therefore, the edge strength, i.e. the likelihood for a pixel to be on an object boundary or an edge, of x is determined as the average of these votes and the edge strength has a value ranging from zero to one, i.e. [0, 1].

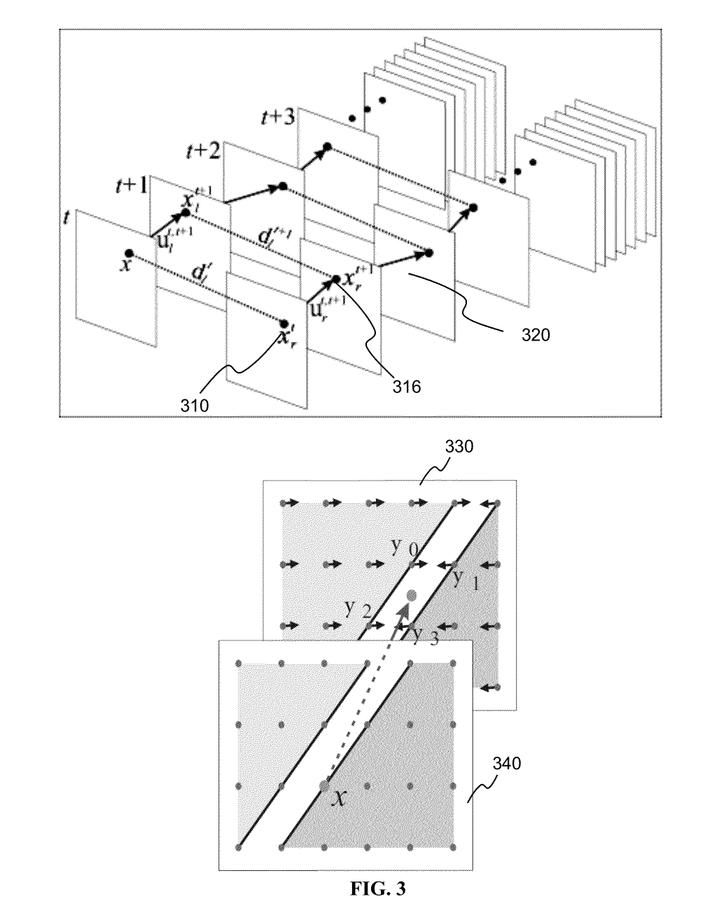

FIG. 3 shows an illustration of how to obtain long-range pixel trajectory in one exemplary embodiment. For each pixel in a frame at time instance t, the trajectory of a pixel is defined by its optical flow correspondences in neighboring frames at other time instances, e.g. t+1, t+2. For example, a pixel on the right frame of the binocular images is denoted by xᵣ 310, its optical flow correspondences are, for example, xᵣ^{t+1} in the frame at time instance t+1. The optical correspondences in neighboring frames are identified by checking if any pixel in the neighboring frames has an optical property, e.g. intensity, matching with that of the pixel in the frame at time instance t. The vector for the motion of the pixel xᵣ 310 between the frame at time instance t and the frame at time instance t+1 is denoted by uᵣ^{t,t+1}. The vector uᵣ^{t,t+1} 320 represents part of the optical flow which forms a trajectory of this pixel xᵣ 310 as long as its optical flow correspondences can be found in other neighboring frames.

For pixel correspondences between consecutive frames, e.g. frame p 330 at time instance t and frame q 340 at time instance t+1, optical flow maps are generated using a variational method. A discussion on variational method is available in Jordan, Michael I., An Introduction to Variational Methods for Graphical Models, Machine Learning, 37, 183-233 and the same is incorporated herein by reference.

For optical flow maps across longer temporal distance, for example, if the optical flow is still available after 30 frames in a sequence of video, a two-step approach is adopted as follows:

Step (1):

In the first step, bilateral interpolation on short-range optical flow maps is used. For example, for optical flow from frame at time instance t to frame at time instance t′=t+2:

$${u}^{t + 1 , {t}^{′}} ( x + {u}^{t} ( x ) ) = \frac{1}{\vert w \vert} {\sum }_{i = 0}^{3} {u}^{t + 1 , {t}^{′}} ( {y}_{i} ) \cdot {e}^{- m} \qquad ( 7 )$$

where m=(x+u^{t}(x)−yᵢ)²/σ₁−(f₁(x)−f₁^{t+1}(y₁))²/σ²

where u^{p+1,q} is the optical flow from frame p at time instance t to frame q at time instance t′, x represents a pixel in frame p at time instance t, w is a weighting function, yᵢ represents a neighboring pixel frame p at time instance t.

Step (2):

In the second step, linearization technique is used to refine the initial long-range flow maps obtained in the first step to achieve higher accuracy.

The trajectory of a pixel is broken once occlusion is detected. Occlusion can be detected by a number of methods, for example, by uniqueness checking where if two pixels on the frame at time instance t are mapped to the same pixel on the target frame, one of the neighboring frames of the frame at time instance t, these two pixels on the frame at time instance t will be labeled as occluded.

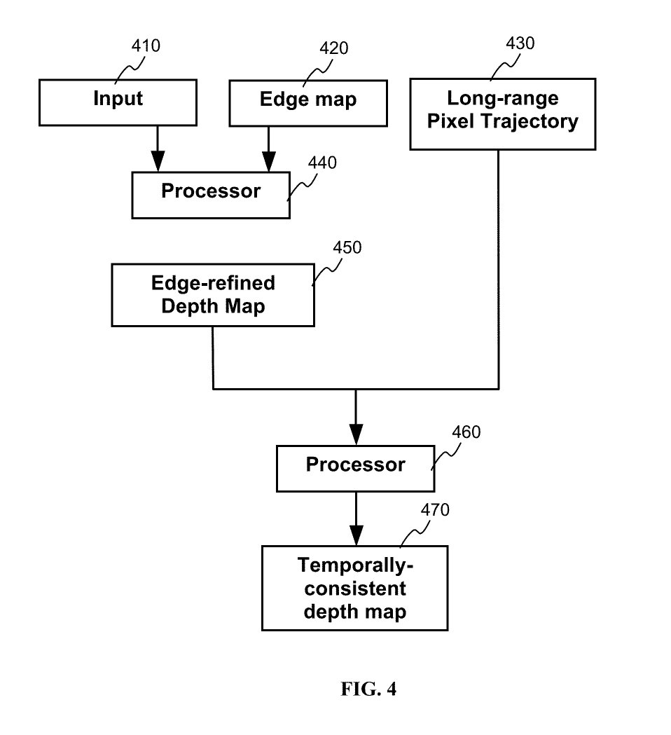

FIG. 4 shows a flowchart of an exemplary embodiment of generation of depth map provided by the present invention. The depth maps generated by the present invention are temporally-consistent so that flickering problems in the depth maps are avoided. Such depth maps are also known as temporally-consistent depth maps 470. Firstly, the edge-refined depth maps 450 are used to preserve salient depth discontinuity and are determined by a processor 440 using the input 410 and the edge maps 420. Secondly, in order to remove the random foreground fattening artifacts, which will persist in the results if merely the edge-refined depth maps 450 are used, long-range pixel trajectory 430 is used to ensure temporal consistency with the help of an averaging step.

In one embodiment, using the pixel trajectory, the temporally-consistent depth maps 470 are obtained by applying Gaussian-weights on initial depth maps of temporal frames by a processor 460:

$${\tilde{d}}^{t} ( x ) = \frac{1}{\vert {w}_{d} \vert} {\sum }_{i}^{ } {d}^{t + i} ( x + {u}^{t + i , t} ( x ) ) {e}^{- {i}^{2} / {σ}_{t}} \qquad ( 8 )$$

where t is the reference frame, and t+i is a neighboring frame.

Such temporally-consistent depth maps 470 preserve both object boundary as well as temporal consistency.

Embodiments of the present invention may be implemented in the form of software, hardware, application logic or a combination of software, hardware and application logic. The software, application logic and/or hardware may reside on integrated circuit chips, modules or memories. If desired, part of the software, hardware and/or application logic may reside on integrated circuit chips, part of the software, hardware and/or application logic may reside on modules, and part of the software, hardware and/or application logic may reside on memories. In one exemplary embodiment, the application logic, software or an instruction set is maintained on any one of various conventional non-transitory computer-readable media.

Processes and logic flows which are described in this specification can be performed by one or more programmable processors executing one or more computer programs to perform functions by operating on input data and generating output.

Processes and logic flows can also be performed by special purpose logic circuitry, e.g., an FPGA (field programmable gate array) or an ASIC (application-specific integrated circuit).

Apparatus or devices which are described in this specification can be implemented by a programmable processor, a computer, a system on a chip, or combinations of them, by operating on input data and generating output. Apparatus or devices can include special purpose logic circuitry, e.g., an FPGA (field programmable gate array) or an ASIC (application-specific integrated circuit). Apparatus or devices can also include, in addition to hardware, code that creates an execution environment for computer program, e.g., code that constitutes processor firmware, a protocol stack, a database management system, an operating system, a cross-platform runtime environment, e.g., a virtual machine, or a combination of one or more of them.

Processors suitable for the execution of a computer program include, for example, both general and special purpose microprocessors, and any one or more processors of any kind of digital computer. Generally, a processor will receive instructions and data from a read-only memory or a random access memory or both. The elements of a computer generally include a processor for performing or executing instructions, and one or more memory devices for storing instructions and data.

Computer-readable medium as described in this specification may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. Computer-readable media may include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

A computer program (also known as, e.g., a program, software, software application, script, or code) can be written in any programming language, including compiled or interpreted languages, declarative or procedural languages, and it can be deployed in any form, including as a stand-alone program or as a module, component, subroutine, object, or other unit suitable for use in a computing environment. A computer program can be deployed to be executed on one computer or on multiple computers that are located at one single site or distributed across multiple sites and interconnected by a communication network.

Embodiments and/or features as described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with one embodiment as described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The whole specification contains many specific implementation details. These specific implementation details are not meant to be construed as limitations on the scope of the invention or of what may be claimed, but rather as descriptions of features specific to particular embodiments of the invention.

Certain features that are described in the context of separate embodiments can also be combined and implemented as a single embodiment. Conversely, various features that are described in the context of a single embodiment can also be implemented in multiple embodiments separately or in any suitable subcombinations. Moreover, although features may be described as acting in certain combinations and even initially claimed as such, one or more features from a combination as described or a claimed combination can in certain cases be excluded from the combination, and the claimed combination may be directed to a subcombination or variation of a subcombination. Although various aspects of the invention are set out in the independent claims, other aspects of the invention comprise other combinations of features from the embodiments and/or from the dependent claims with the features of the independent claims, and not solely the combinations explicitly set out in the claims.

Certain functions which are described in this specification may be performed in a different order and/or concurrently with each other. Furthermore, if desired, one or more of the above-described functions may be optional or may be combined.

The above descriptions provide exemplary embodiments of the present invention, but should not be viewed in a limiting sense. Rather, it is possible to make variations and modifications without departing from the scope of the present invention as defined in the appended claims.

What is claimed is:

1. A method for generating temporally-consistent depth map by one or more processors receiving a sequence of images, comprising:
receiving one first pair of images in the sequence of images of time instance t and at least one second pair of images in the sequence of images from other time instances t+i wherein each pair of images being different views of the same scene;
generating a segmentation map of a third image by clustering a plurality of pixels in the image into a plurality of image regions, wherein the third image being one of the first pair of images;
generating a long-range pixel trajectory of the third image by identifying a correspondence between each pixel in the third image and each pixel in one of the second pair of images;
generating a temporally-consistent edge map of the third image by determining the probability of each pixel in the third image being an object boundary using the segmentation map and the long-range pixel trajectory;
generating an edge-refined depth map for the first pair of images using the temporally-consistent edge map such that probability of each pixel in the third image being a depth discontinuity is determined based on probability of the pixel being on an object boundary; and
generating a temporally-consistent depth map for the first pair of images from the edge-refined depth map using the long-range pixel trajectory to adjust depth of each pixel in the third image according to optical flow of the pixel in at least one image in the sequence of images at other time instances.

2. The method of claim 1, further comprising:
concatenating a plurality of short-range optical flow maps for the generation of the long-range pixel trajectory.

3. The method of claim 2, further comprising:
processing the plurality of short-range optical flow maps using bilateral interpolation to obtain a plurality of interpolated optical flow maps; and
processing the interpolated optical flow maps using linearization.

4. The method of claim 3, further comprising:
determining an occlusion status of a pixel in the third image by checking if at least one other pixel in the third image having same correspondence in an image at time instance t+i.

5. The method of claim 1, further comprising:
the segmentation map is generated from mean-shift segmentation.

6. The method of claim 5, further comprising;
determining if a second correspondence in an image at time instance t+i of a second pixel which is neighboring to a first pixel belongs to the same segment as a first correspondence in an image at time instance t+i of the first pixel does according to the segmentation map.

7. The method of claim 6, wherein:
the correspondence in the image at time instance t+i of a pixel is determined by an optical flow of the pixel.

8. The method of claim 7, further comprising:
increasing the probability of the first pixel being on an object boundary if it is determined that the first correspondence and the second correspondence belongs to different segments according to the segmentation map.

9. The method of claim 1, further comprising:
adjusting a depth value of a first pixel in the edge-refined depth map to have a difference between one or more depth values of one or more second pixels neighboring to the first pixel depending on the probability of the first pixel being a depth discontinuity to give an adjusted depth value of the first pixel; and
generating an adjusted depth map by obtaining the adjusted depth value for each pixel of an image.

10. The method of claim 9, further comprising:
processing a plurality of adjusted depth maps for images at different time instances by averaging the adjusted depth maps with Gaussian-weights.

11. An apparatus for generating temporally-consistent depth map comprising one or more processors for performing the steps of:
receiving one first pair of images in the sequence of images of time instance t and at least one second pair of images in the sequence of images from other time instances t+i wherein each pair of images being different views of the same scene;
generating a segmentation map of a third image by clustering a plurality of pixels in the image into a plurality of image regions, wherein the third image being one of the first pair of images;
generating a long-range pixel trajectory of the third image by identifying a correspondence between each pixel in the third image and each pixel in one of the second pair of images;
generating a temporally-consistent edge map of the third image by determining the probability of each pixel in the third image being an object boundary using the segmentation map and the long-range pixel trajectory;
generating an edge-refined depth map for the first pair of images using the temporally-consistent edge map such that probability of each pixel in the third image being a depth discontinuity is determined based on probability of the pixel being on an object boundary; and
generating a temporally-consistent depth map for the first pair of images from the edge-refined depth map using the long-range pixel trajectory to adjust depth of each pixel in the third image according to optical flow of the pixel in at least one image in the sequence of images at other time instances.

12. The apparatus of claim 11, wherein the processor is further configured to:
concatenate a plurality of short-range optical flow maps for the generation of the long-range pixel trajectory.

13. The apparatus of claim 12, wherein the processor is further configured to:
process the plurality of short-range optical flow maps using bilateral interpolation to obtain a plurality of interpolated optical flow maps; and
process the interpolated optical flow maps using linearization.

14. The apparatus of claim 13, wherein the processor is further configured to:
determine an occlusion status of a pixel in the third image by checking if at least one other pixel in the third image having same correspondence in an image at time instance t+i.

15. The apparatus of claim 11, wherein:
the segmentation map is generated from mean-shift segmentation.

16. The apparatus of claim 15, wherein the processor is further configured to:
determine if a second correspondence in an image at time instance t+i of a second pixel which is neighboring to a first pixel belongs to the same segment as a first correspondence in an image at time instance t+i of the first pixel does according to the segmentation map.

17. The apparatus of claim 16, wherein:
the correspondence in the image at time instance t+i of a pixel is determined by an optical flow of the pixel.

18. The apparatus of claim 17, wherein the processor is further configured to:
increase the probability of the first pixel being on an object boundary if it is determined that the first correspondence and the second correspondence belongs to different segments according to the segmentation map.

19. The apparatus of claim 11, wherein the processor is further configured to:
adjust a depth value of a first pixel in the edge-refined depth map to have a difference between one or more depth values of one or more second pixels neighboring to the first pixel depending on the probability of the first pixel being a depth discontinuity to give an adjusted depth value of the first pixel; and
generate an adjusted depth map by obtaining the adjusted depth value for each pixel of an image.

20. The apparatus of claim 19, wherein the processor is further configured to:
process a plurality of adjusted depth maps for images at different time instances by averaging the adjusted depth maps with Gaussian-weights.
